(19) United States
(12) Patent Application Publication
(10) Pub. No.: US 2014/0294006 A1
(43) Pub. Date: Oct. 2, 2014

(54) DIRECT SERVICE MAPPING FOR NAT AND PNAT

(71) Applicant: Carl J. Rajsic, Ottawa (CA)

(72) Inventor: Carl J. Rajsic, Ottawa (CA)

(73) Assignee: ALCALTEL-LUCENT CANADA INC., Ottawa (CA)

(21) Appl. No.: 13/853,447

(22) Filed: Mar. 29, 2013

(51) Int. Cl. H04L 29/12; H04L 12/741

(52) U.S. Cl. CPC H04L 61/2503; H04L 45/74
USPC 370/392

(57) ABSTRACT

Various exemplary embodiments relate to a method of processing a packet at a firewall. The method includes: receiving a packet having a source address, destination address, source port, and destination port; comparing the packet to match criteria of a rule, wherein the match criteria includes at least one service group having a plurality of port combinations; matching both the source port and destination port with one of the plurality of port combinations; determining an index into the service group of the matching port combination; and translating a port of the packet based on the index into the service group and a NAT service group defined for the rule.

### TECHNICAL FIELD

Various exemplary embodiments disclosed herein relate generally to communications networks.

### BACKGROUND

Firewalls are used by network administrators to control network traffic. A network administrator typically configures a number of rules for processing packets. Rules are often in the form of conditional statements. For example, rules for Network Address Translation (NAT) may define matching packet criteria and NAT translations. A network administrator must often configure such rules individually for different hosts and services. Such configuration can be tedious.

### SUMMARY

In view of the foregoing, it would be desirable to provide an improved structure for firewall rules to enable easier configuration. In particular, it would be desirable to provide a firewall that uses rules including service groups for configuring firewall behavior for multiple hosts and services. Service groups may be lists of services that include source ports, destination ports and IP protocols that relate to a particular rule.

In light of the present need for improved firewall configuration and control, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of processing a packet at a firewall. The method includes: receiving a packet having a source address, destination address, source port, and destination port; comparing the packet to match criteria of a rule, wherein the match criteria includes at least one service group having a plurality of port combinations; matching both the source port and destination port with one of the plurality of port combinations; determining an index into the service group of the matching port combination; and translating a port of the packet based on the index into the service group and a NAT service group defined for the rule.

In various embodiments, the index into the service group is a row of the service group. The index into the service group may further include an offset into a range of ports within the row. In such embodiments, the step of translating the port of the packet may include adding the offset to the first port number in a range of port numbers in a row of the NAT service group.

In various embodiments, the method further includes: matching either the source address or destination address with an address of the match criteria of the rule; and translating the matching address of the packet based on a NAT option address of the rule.

In various embodiments, the method further includes: translating a network address of the packet based on the index into the service group and the rule, wherein the rule comprises a NAT option including a NAT host group and the NAT service group.

In various embodiments, the method further includes: translating a network address of the packet based on an index into a matching host group independently of the index into the matching service group, wherein the rule comprises the matching host group and a NAT option including a NAT host group and the NAT service group.

In various embodiments, the method further includes: configuring the rule via an operator interface.

Various exemplary embodiments relate to the above described methods encoded on a tangible machine-readable storage medium as instructions executable by a firewall.

Various exemplary embodiments relate to a firewall. The firewall may include: an ingress interface that receives a packet having a source address, destination address, source port, and destination port; a rule storage comprising a plurality of active rules, at least one active rule including a matching criteria service group including a plurality of rows of source and destination port combinations and a NAT service group; a matching engine configured to: compare the source port and destination port to the plurality of rows of source and destination port combinations, find a matching row; and determine an index of the matching row; a translation engine configured to translate the source and destination ports of the packet to source and destination ports indicated by the NAT service group based on the index of the matching row; and an egress interface configured to transmit the packet to the destination address.

In various embodiments, the firewall further includes: an operator interface configured to allow an operator to configure the active rules.

In various embodiments, the index into the service group is a row of the service group. The index into the service group may further include an offset into a range of ports within the row. In such embodiments, the translation engine may be further configured to translate a network address of the packet based on the index into the service group and the at least one active rule, wherein the at least one active rule includes a NAT option including a NAT host group and the NAT service group.

In various embodiments, the translation engine is further configured to translate a network address of the packet based on an index into a matching host group independently of the index into the matching service group, wherein the active rule includes the matching host group and a NAT option including a NAT host group and the NAT service group.

It should be apparent that, in this manner, various exemplary embodiments enable an improved structure for firewall rules to enable easier configuration. In particular, by providing a firewall that uses rules including service groups, the firewall may be configured for multiple hosts and services.

### BRIEF DESCRIPTION OF THE DRAWINGS

In order to better understand various exemplary embodiments, reference is made to the accompanying drawings, wherein:

FIG. 1 illustrates an exemplary communications network;

FIG. 2 schematically illustrates an exemplary firewall;

FIG. 3 illustrates an exemplary data arrangement for a rule table;

FIG. 4 illustrates an exemplary data arrangement for a service group;

FIG. 5 illustrates a flowchart showing a method of processing packets; and

FIG. 6 illustrates a flowchart showing a method of performing service group direct mapping.

### DETAILED DESCRIPTION

Referring now to the drawings, in which like numerals refer to like components or steps, there are disclosed broad aspects of various exemplary embodiments.

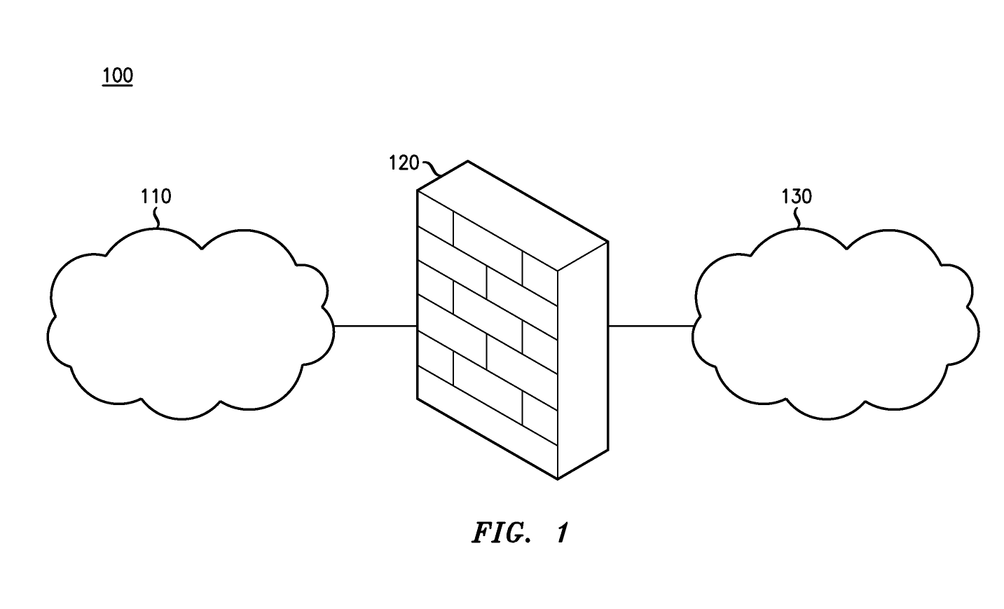

FIG. 1 illustrates an exemplary communications network 100. Communications network 100 may include public network 110, firewall 120, and private network 130.

Public network 110 may be a communications network where access is unrestricted. For example, network 110 may be a public land mobile network, service provider network, or the internet. Users may be able to connect to network 110 using a variety of network devices such as, for example, computers, mobile devices, and servers. The various network devices may communicate with each other using known protocols such as, for example, the internet protocol suite.

Firewall 120 may be one or more network devices configured to control communications with private network 130. Firewall 120 may be physically or operationally connected such that all communications directed to or from private network 130 must pass through firewall 120. Accordingly, firewall 120 may receive communications packets from devices within public network 110 directed to devices within private network 130 and vice versa. Firewall 120 may be configured with various rules for determining how packets are treated. Firewall 120 may be configured to perform various operations on the communications packets including: analyze packets, route packets, drop packets, alter packets, send packets, forge packets, or any other operations allowed by the protocols used.

In particular, one technique used by firewall 120 may be network address translation (NAT) or port network address translation (PNAT). At a very basic level, NAT is used to change, or translate, the network addresses of packets. Similarly, PNAT is used to change, or translate, the ports of packets. Network administrators managing a network device such as a router or firewall may configure various rules for performing NAT operations. In various known systems, NAT rules must be configured using conditional statements. The network administrator must designate particular addresses and port numbers and indicate how matching packets should be translated. Such a process may be difficult or tedious. Manual designation of addresses and port numbers may also lead to inconsistency, errors, security breaches, or unavailable service.

Private network 130 may be any network where communications are controlled. For example, private network 130 may be a network controlled by a private enterprise, government agency, university, or any other network controlled by a firewall 120. Private network 130 may be controlled by a network administrator configuring firewall 120. For example, the network administrator may use firewall 120 to perform NAT operations in order to hide information regarding the structure of private network 130 to public network 110. For example, firewall 120 may be configured such that network addresses of all incoming and outgoing traffic are translated in order to hide the internal structure of network 130.

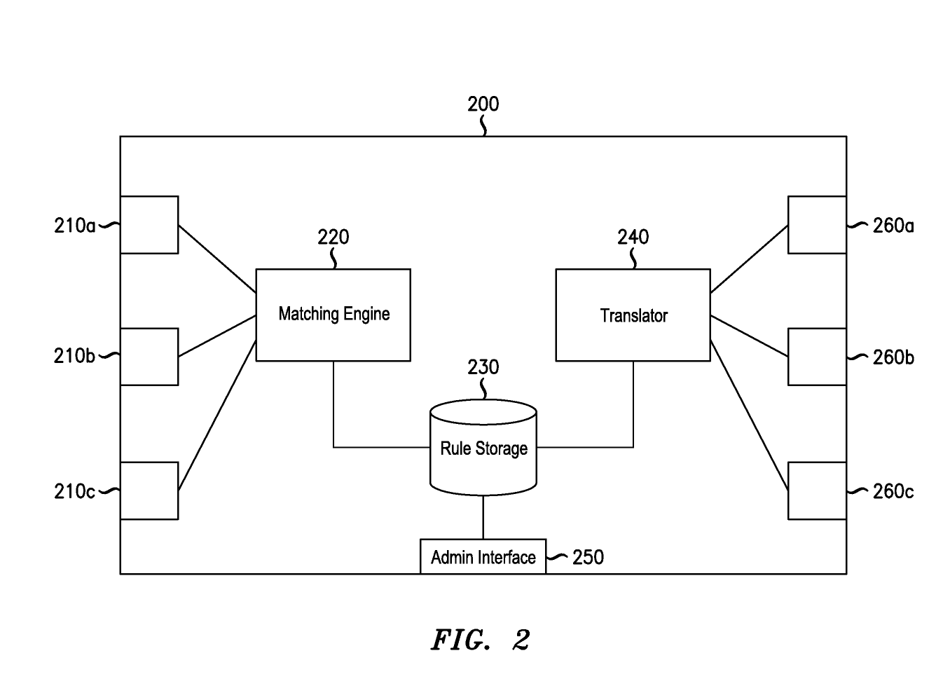

FIG. 2 schematically illustrates an exemplary firewall 200. Firewall 200 may be a firewall such as firewall 120 configured to protect a private network 130. Firewall 200 may include: a plurality of ingress interfaces 210, a matching engine 220, a rule storage 230, a translator 240, an administrator interface 250, and a plurality of egress interfaces 260.

Ingress interfaces 210 may be network adapters such as line cards configured to receive signals from a transmission medium and convert the signals into data packets. It should be appreciated that ingress interfaces 210 may be a logical role performed by the interface for a particular packet. An interface may act as both an ingress interface 210 and an egress interface 260.

Matching engine 220 may be a processor, controller, or module configured to analyze ingress packets. In particular, matching engine 220 may be configured to receive packets and determine whether header information of the packet matches various criteria defined by processing rules. For example, matching engine 220 may determine whether a packet matches address or port numbers for which NAT is to be performed. As will be described in further detail below, matching engine 220 may be configured to match a packet against a service group and determine a service group index for a matching packet. Matching engine 220 may compare received packets to active rules defined in rule storage 230. Matching engine 220 may pass packets and matching criteria and rules to translator 240.

Rule storage 230 may be any computer readable storage memory capable of storing a plurality of active rules. For example rule storage 230 may be a computer memory such as a Random Access Memory (RAM), Read Only Memory (ROM), cache, hard disc, or flash drive. Rule storage 230 may include a set of active rules currently being enforced by the firewall 200. Rule storage 230 may also include other rule related information such as inactive rules and rule components. An inactive rule may be a defined rule that is not currently being enforced by the firewall 200. For example, firewall 200 may have various rules that are only enforced at certain times of day or at certain threat levels. Inactive rules may also include rules under development and testing. Rule components may include conditions, lists, groupings, combinations, ranges, or other data arrangements that may be used in various rules. For example, as will be described in further detail below, rule components may include service groups. A service group may include a defined list of network services to which a particular rule may be applicable. Services in a service group may include source ports, destination ports and protocol identifiers. Another example of a rule component may be a host group, which may include a defined list of host addresses to which a particular rule may be applicable.

Translator 240 may be a processor, controller, or module configured to apply NAT translations to packets. In various embodiments, translator 240 may be the same physical device as matching engine 220, but perform different operations on a packet. Translator 240 may receive packets and information regarding matching rules from matching engine 220. Translator 240 may be configured to translate host addresses and port numbers based on the matching rules. As will be described in further detail below, translator 240 may be configured to translate port numbers based on a service group index. Translator 240 may maintain a translation table for known translations. Accordingly, translator 240 may be able to receive packets back from network devices where host and port information has been translated and determine the original host and port information.

Administrator interface 250 may be an interface used by a network administrator to configure firewall 200. The administrator interface 250 may be a physical interface that allows the network administrator to directly access rule storage 230. Alternatively, administrator interface 250 may provide an authenticated network administrator with remote access to rule storage 230.

Egress interfaces 260 may be network adapters such as line cards configured to transmit data packets over a communications medium. Egress interfaces 260 may receive data packets from translator 240 and transmit the packets to a destination host and port indicated by the translated packet. As discussed above, it should be appreciated that egress interfaces 260 may be a logical role performed by the interface for a particular packet. It should be known to those skilled in the art of firewall applications that egress interfaces 260 may be the same interfaces as ingress interfaces 210 and vice versa.

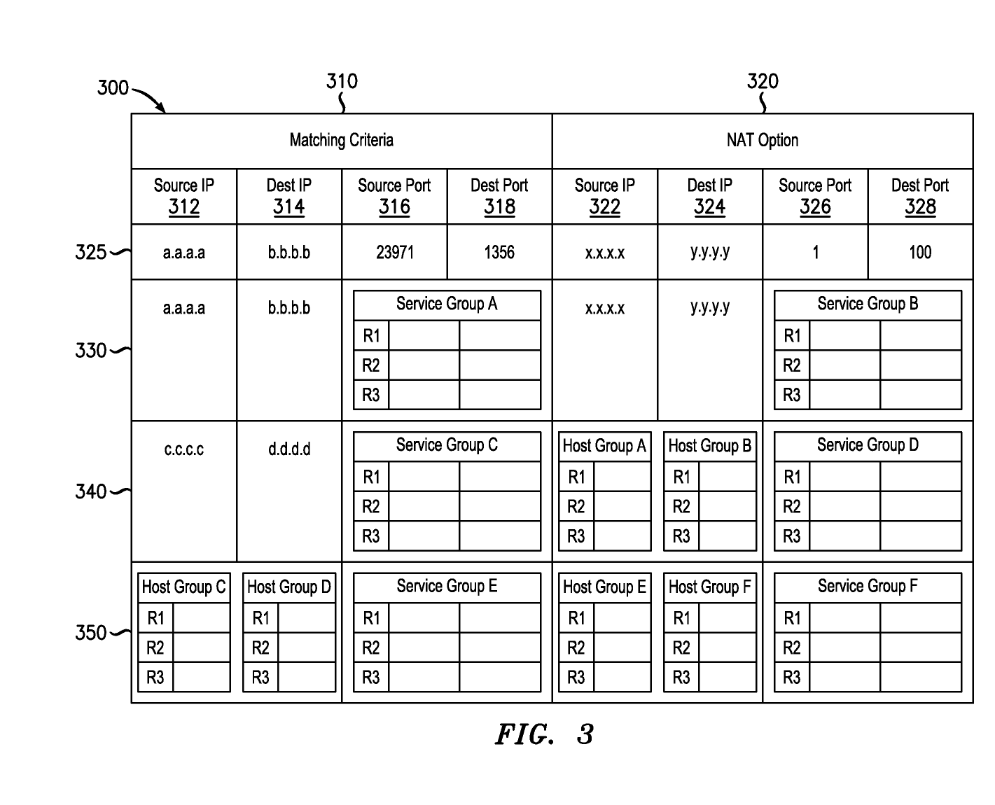

FIG. 3 illustrates an exemplary data arrangement for a rule table 300. Rule table 300 may be stored in rule storage 230. Rule table 300 may represent the active rules selected by an operator to be enforced by firewall 200. Rule table 300 may alternatively represent a list of rules that may be selected as active rules. Rule table 300 may include a plurality of rules that may be used by firewall 200 to control network traffic. Each rule may include a matching criteria portion 310 and a NAT Option portion 320. The matching criteria portion 310 may include a source IP 312, destination IP 314, source port 316, and destination port 318. When a service group is used in a rule, the source port 316 and destination port 318 may be replaced by the service group. Similarly, the NAT option may include source IP 322, destination IP 324, source port 326, and destination port 328. When a service group is used in a rule, the source port 326 and destination port 328 may be replaced by the service group.

The source IP 312, destination IP 314, source IP 322, and destination IP 324 may each be network addresses of a host, or a range of network addresses. The term “host address” may refer to either a source or destination network address. For simplicity, the network addresses will be described as IPv4 addresses. It should be appreciated that the network addresses may be IPv6 addresses, or any other network address designating a host machine.

The source port 316, destination port 318, source port 326, and destination port 328 may each be a network port number or range of port numbers. As will be described in further detail below, a combination of a source port 316 and destination port 318 may be designated by a service group having one or more combinations of source and destination ports. Similarly, a combination of source port 326 and destination port 328 may be designated by a service group.

The rule table 300 may include a plurality of rules such as, for example, exemplary rules 325, 330, 340, and 350. It should be appreciated that a network operator may configure firewall 200 with various rules. A network operator may include known rule types in addition to rules similar to exemplary rules 325, 330, 340, and 350 using service groups.

Exemplary rule 325 may include explicitly defined values in both the matching criteria portion 310 and the NAT option 320. More specifically, The source IP 312 may be an address a.a.a.a, the destination IP 314 may be an address b.b.b.b, the source port 316 may be 2397, and the destination port 1356 may be 1356. If a packet matches the matching criteria portion 310 of rule 325, the source IP 3122 may be translated to the address x.x.x.x, the destination ip 324 may be translated to y.y.y.y, the source port 326 may be translated to 1, and the destination port 328 may be translated to 100.

Exemplary rule 330 may be a rule having the port numbers for both the matching criteria 310 and the NAT option 320 defined as a service group. For example, the rule 330 may define source ports and destination ports within service group A. As will be described in further detail below, service group A may represent any group of services for which firewall 200 may provide similar processing for packets that match source IP a.a.a.a and destination IP b.b.b.b. The different services of service group A may be defined by the rows R1, R2, R3, of service group 1. The network addresses of rule 330 may be defined individually. The network addresses may include ranges of network addresses or use wildcard symbols to represent multiple network addresses. As will be described in further detail below, the matching engine 220 may compare received packets to the matching criteria 310. Rule 330 may be applicable to any packet having header information matching the source IP 312, destination IP 314, and port numbers matching any row of service group A. As will be described in further detail below, the translator 240 may change the header information including network addresses and port numbers according to the NAT option 320 of rule 330. In particular, the translator 240 may use an index into service group A to determine the new port numbers according to service group B.

Exemplary rule 340 may be a rule using service groups having individually designated network addresses in the matching criteria 310 and host groups defined for the NAT option 320. Similarly to rule 330, rule 340 may be applicable to any packet having header information matching the source IP 312 (i.e. c.c.c.c), destination IP 314 (i.e. d.d.d.d), and port numbers matching any row of service group C. As will be explained in further detail below, translator 240 may use an index into service group C to determine new port numbers according to service group D and to determine new source IP 322 according to host group A and new destination IP 324 according to host group B. Accordingly, in rule 340, the NAT address and port numbers may both be based on the matching row of service group C in the matching criteria 310.

Exemplary rule 350 may illustrate a rule using both host groups and service groups in the matching criteria 310, as well as the NAT option 320. The matching engine 220 may determine that rule 350 is applicable when the received packet header information includes a source IP matching any row of host group C, a destination IP matching any row of host group D, and a source and destination port combination matching any row of service group E. Matching engine 220 may determine an index into each host group and an index into the service group E. As will be explained in further detail below, the host group indices may be used to determine a new network address according to host group E and host group F using direct host mapping. The index into service group E may be used to determine the new port numbers based on service group F. Accordingly, rule 350 may be used to provide separate host group direct translation and service group port translation on the same packet.

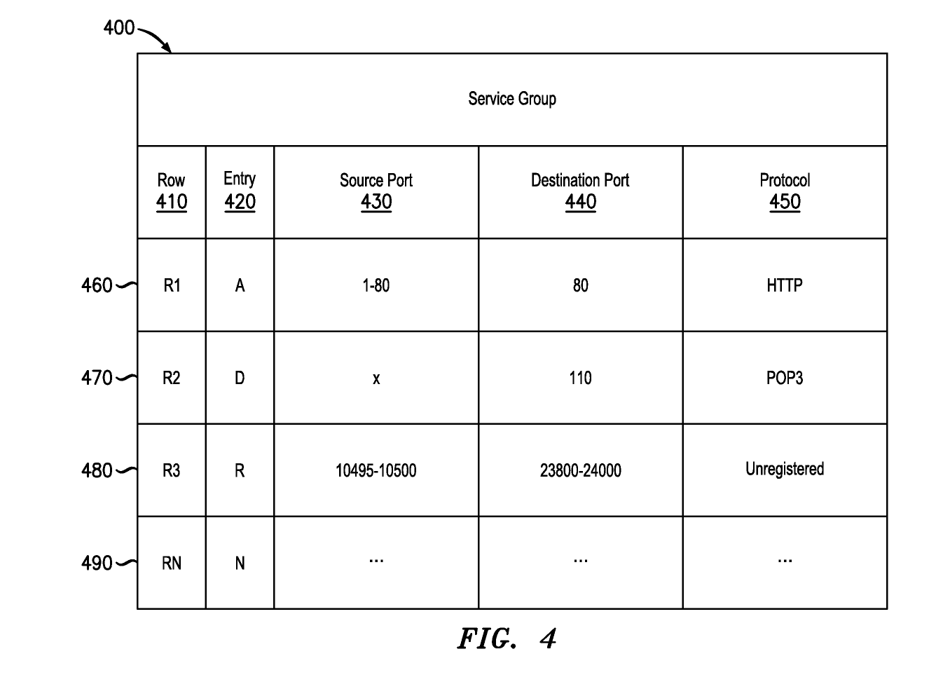

FIG. 4 illustrates an exemplary data arrangement for a service group 400. Service group 400 may be, for example, any one of service groups A-E illustrated in FIG. 3. Service group 400 may include a plurality of rows having entries. Each entry may include various fields including row 410, entry 420, source port 430, destination port 440, and protocol 450. Exemplary rows 460, 470, 480, 490 may illustrate examples of entries in service group 400.

Row field 410 may indicate a row number for an entry. The values of row field 410 may be sequential for a service group 400. The service group 400 may not include empty rows. As will be described in further detail below, the matching row field 410 may be used as at least part of an index into the service group.

Entry field 420 may indicate an independent identifier for an entry in service group 400. The entry field 420 may store any identifier for the information in the row. Accordingly, entry field 420 may be used to identify information for a service outside of service group 400 or across different service groups 400. For example, entry field 420 may identify the information for a service whether it is stored as a separate service rule component, as an entry in a first service group used in a matching criteria 310, or as an entry in a second service group used in a NAT option 320.

Source port field 430 may be used to identify a source port for a service. The source port field 430 may include an individual port number, range of port numbers or wild card symbols. Where the source port field 430 includes a range of source ports, the index into the service group may include an index into the range in addition to the row field 410.

Destination port field 440 may be used to identify a destination port for a service. The destination port field 440 may include an individual port number, range of port numbers, or wild card symbols. Where the destination port field 440 includes a range of source ports, the index into the service group may include an index into the range in addition to the row field 410.

Protocol field 450 may be used to identify a protocol associated with the entry. The protocol field 450 may include a name or other identifier of a protocol. The protocol field 450 may be used by an operator to identify the service. In various embodiments, the protocol field 450 may be ignored by the firewall 200, left blank, or completely absent.

Exemplary entry 460 may illustrate an entry in R1, having an entry ID A that is designated for source ports 1-80 and destination port 80. Exemplary entry 460 may use, for example, the HTTP protocol. Exemplary entry 470 may illustrate an entry in R2, having an entry ID D that is designated for any source port using a wildcard symbol and a destination port of 110. Accordingly, a packet may match entry 470 if only the destination port matches the destination port field 440. A wildcard symbol may also be used in source port field 430 to indicate that any port number may match the source port. Exemplary entry 470 may use, for example, the POP3 protocol. Exemplary entry 480 may illustrate an entry in R3 having an entry ID R that is designated for source ports 10495-10500 and destination ports 23800-24000. Exemplary entry 480 may use an unregistered protocol. Exemplary entry 490 may illustrate that service group 400 may include any number of entries.

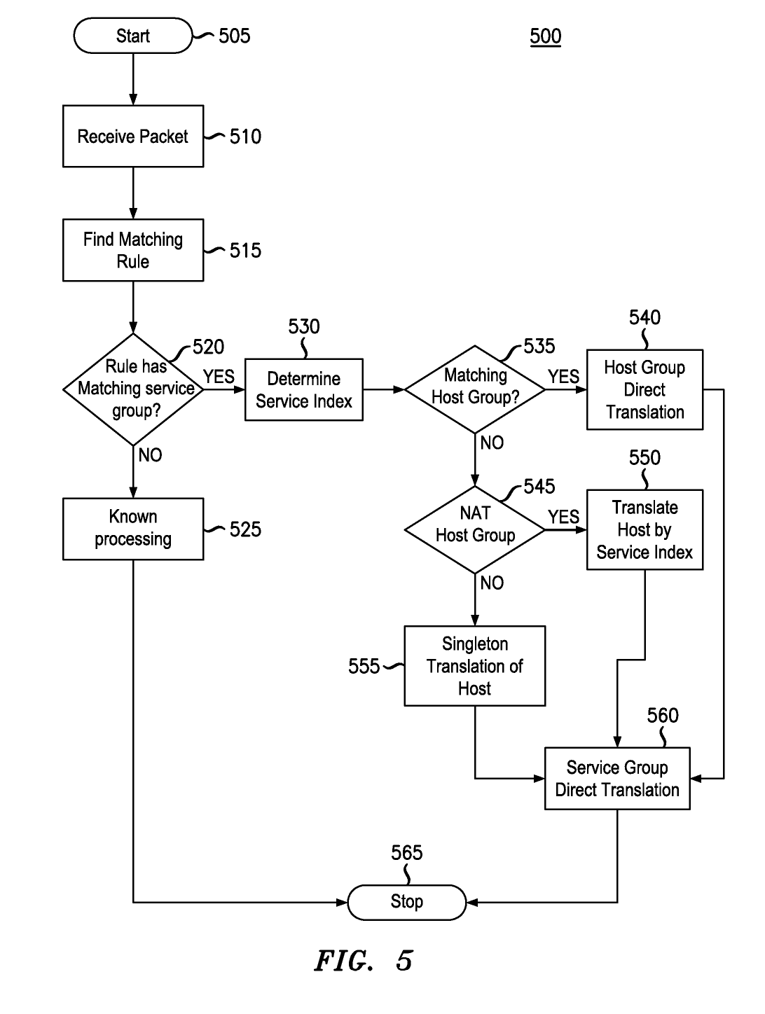

FIG. 5 illustrates a flowchart showing a method 500 of processing packets. The method 500 may be performed by the various components of firewall 200. The method 500 may begin at step 505 and proceed to step 510.

In step 510 the firewall 200 may receive a packet at one of ingress interfaces 210. The ingress interface 210 may forward the packet to matching engine 220.

In step 515, the matching engine 220 may find a matching rule for the received packet. The matching engine 220 may compare fields of the packet header information with matching criteria 310. In particular, the matching engine 220 may evaluate the rules in rule table 300 in order and determine whether the received packet matches each rule. A packet may match a rule if the source IP address, destination IP address, and combination of source port and destination port match the criteria defined for the rule. For the source IP, a source of the packet may match an individually defined address, a range of addresses, or an address in a host group defined in source IP field 310. For the destination IP, a destination of the packet may match an individually defined address, a range of addresses, or an address in a host group defined in destination IP field 320. For the combination of source and destination ports, the combination may exactly match a combination defined in source port field 316 and destination port field 318. Where a service group is used to define the port field 316 and 318, the received packet must match a row of the service group to be considered a match. If only one of the ports matches, or only one of the addresses matches, matching engine 220 may determine that the packet does not match the rule. A wildcard symbol may be used to designate a combination where only one of the ports needs to match.

In step 520, the matching engine 220 may determine whether the rule has a matching service group in the matching criteria 510. The rule may have a matching service group if a service group is used to define the matching source and destination ports. If there is no service group in the matching criteria 510 for the matching rule, the method 500 may proceed to step 525. If there is a service group in the matching criteria 510 for the matching rule, the method 500 may proceed to step 530.

In step 525, the packet may be processed according to any known processing technique. The method may then proceed to step 565, where the method ends.

In step 530, the matching engine 220 may determine a service index into the service group. In various embodiments, the service index may be the row number of the matching combination of source and destination ports. As will be described in further detail below, the service index may also include an offset into a defined range of ports. Matching engine 220 may pass the packet and the service index to translator 240.

In step 535, the translator may determine whether the matching criteria 310 includes a matching host group. The matching criteria 310 may include a matching host group if either the source IP field 312 or the destination IP field 314 is defined by a host group. If the matching criteria 310 includes a matching host group, the method 500 may proceed to step 540. If the matching criteria 310 does not include a matching host group, the method 500 may proceed to step 545.

In step 540, the translator may perform host group direct translation independently of the service group. The translator 240 may determine a host offset of the matching host address into the host group. The host offset may be based on both the size of the ranges of host addresses and the row where the matching address is found. The rows may be considered as sequential ranges of host addresses. For example, the host group may defined as: R1: 1.1.1.1-1.1.1.12; R2: 1.2.3.4; and R3: 10.1.20.8. The example host group may include fourteen addresses. As examples, the address 1.1.1.1 may have an offset of 0, the address 1.1.1.8 may have an offset of 7, and the address 1.2.3.4 may have an offset of 12. The host offset may then be used to translate the matching host address into a NAT address based on a second host group defined in the NAT option. Translator 320 may determine the host address in the second host group having the same offset. For example, the second host group may be defined as: R1: 128.1.1.1; R2: 192.1.1.6; R3: 244.3.5.3. If the host offset is 0, the address may be translated to 128.1.1.1. If the host offset is 3, the address may be translated to 244.3.5.3. For host address translation, the host addresses may wrap around if the second host group is smaller than the first host group. Accordingly, if the host offset is 1, 4, 7, or 11, the address may be translated to 192.1.1.6. In various embodiments, the administrator interface 250 may require rules to have host groups in the NAT option be at least the same size as the corresponding host group in the matching criteria.

Host group matching for source addresses and destination addresses may be similar. A rule may define a NAT translation for only the source address or only the host address using a host group. If a host group is not defined for one of the addresses, the address without a defined host group may be translated according to singleton translation or not translated. Once the host addresses have been translated, the method 500 may proceed to step 560.

In step 545, the translator 240 may determine whether the NAT option 520 for the rule having no host group in the matching criteria 510 includes a host group. If the NAT option 320 includes a host group, the method 500 ma proceed to step 550. If the NAT option 320 does not include a host group, the method 500 may proceed to step 555.

In step 550, the translator 240 may translate the host address based on the service index. The translator 240 may select a row of the host group that is the same as the row of the matching service group. The translator 240 may then select an individual address defined for the row, or select the first address defined in a range or addresses. If the service group includes more rows than the host group, the host group rows may be allowed to wrap around such that the translator makes a selection. Again, in various embodiments, the administrator interface may require the host group to have at least the same number of rows as a service group. As described above regarding step 540, either one or both of the source and destination addresses may be translated in a similar manner.

In step 555, the translator 240 may perform singleton translation of the host address. The translator 240 may simply replace the matching host address with the host address defined for the NAT option 320. Once the host addresses are translated, the method 500 may proceed to step 560,

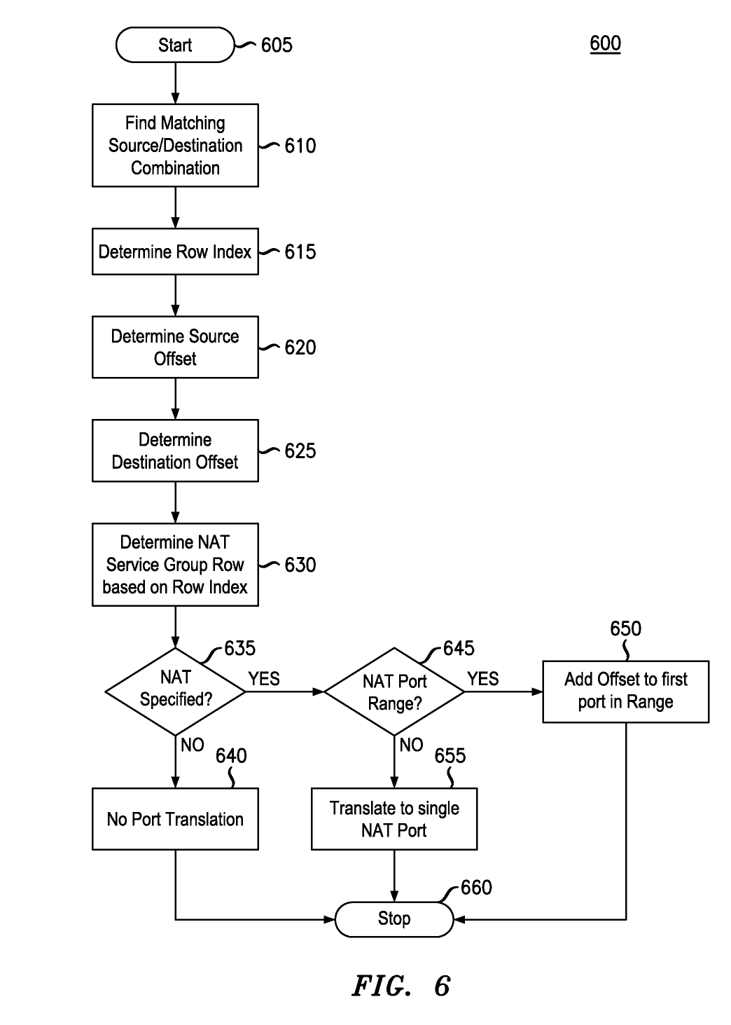

In step 560, the port numbers may be translated using service group direct translation based on the service index. Service group direct translation will be described in further detail below regarding FIG. 6. Once the port numbers have been translated, the method 500 may proceed to step 565, where the method 500 ends.

FIG. 6 illustrates a flowchart showing a method 600 of performing service group direct mapping. The method 600 may be performed by the various components of firewall 200 including matching engine 220 and translator 240. The method 600 may correspond to steps 530 and 560 of method 500. The method 600 may begin at step 605 and proceed to step 610.

In step 610, the matching engine 220 may find the matching source port and destination port combination within a service group. As discussed above, in order for a row to match, the source port must match the source port field 430 for the row and the destination port must match the destination port field 440 of the row.

In step 615, the matching engine 220 may determine the row index of the matching row. The row index may be the row number 410 of the matching row.

In step 620, the matching engine 220 may determine the source offset. The source offset may be an offset into a range of ports defined in source port field 430. If source port field 430 of the matching row is a single port number or is a wildcard, the source offset may be 0. If the source port field 430 of the matching row includes a range of port numbers, the source offset may be determined by subtracting the first port number in the range from the source port number of the packet.

In step 625, the destination offset may be determined in a similar manner to the source offset. If the destination port field 440 includes a single port number or a wildcard symbol, the destination offset may be 0. If the destination port field 440 includes a range of port numbers, the first port number may be subtracted from the destination port number of the packet. After step 625, the matching engine 220 may pass the row index, source offset, and destination offset to translator 240 as the service index.

In step 630, the translator 240 may determine the NAT service group row based on the row index. The NAT service group row may be the same as the row of the matching criteria service group. If the NAT service group has fewer rows than the matching criteria service group and no row matches the row index, the firewall 200 may drop the packet. Alternatively, administrator interface 230 may validate rules to ensure that the NAT service group has the same number of rows as the corresponding matching criteria service group.

Steps 635 to step 660 may be performed for both the source port and the destination port individually. In step 635, the translator may determine whether NAT port translation is specified for the source port or destination port. The translator 240 may determine whether the selected row of the NAT service group specifies at least one port. If NAT port translation is specified, the method may proceed to step 645. If NAT port translation is not specified, the method 600 may proceed to step 640.

In step 640, the translator 240 may determine that no port translation is required for the port and the method 600 may proceed to step 660, where the method 600 ends.

In step 645, the translator 240 may determine whether the NAT service group row defines a port range or a single port number. If the NAT service group row defines a port range, the method may proceed to step 650. If the NAT service group row defines a single port, the method 600 may proceed to step 655.

In step 650, the translator 240 may add either the source offset or the destination offset to the first port in the range depending on the type of port. Accordingly, if the matching row included only a single port or a wildcard, the offset of 0 will be added, thereby selecting the first port in the range. Otherwise, the offset will select the port that is the same distance into the range of port numbers in the NAT service group row that the matching port was into the range of port numbers in the matching criteria service group row. The method 600 may then proceed to step 660, where the method ends.

In step 655, the translator 240 may translate the port number to the single defined NAT port regardless of the source offset or destination offset. Accordingly, an operator may configure service groups to perform a many to one mapping of services. The method 600 may then proceed to step 660 where the method 600 ends.

According to the foregoing, various exemplary embodiments provide for an improved structure for firewall rules to enable easier configuration. In particular, by providing a firewall that uses rules including service groups, the firewall may be configured for multiple hosts and services.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of processing a packet at a firewall, the method comprising:
receiving a packet having a source address, destination address, source port, and destination port;
comparing the packet to match criteria of a rule, wherein the match criteria includes at least one service group having a plurality of port combinations;
matching both the source port and destination port with one of the plurality of port combinations;
determining an index into the service group of the matching port combination; and
translating a port of the packet based on the index into the service group and a NAT service group defined for the rule.

2. The method of claim 1, wherein the index into the service group is a row of the service group.

3. The method of claim 2, wherein the index into the service group further includes an offset into a range of ports within the row.

4. The method of claim 3, wherein the step of translating the port of the packet comprises adding the offset to the first port number in a range of port numbers in a row of the NAT service group.

5. The method of claim 1, further comprising:
matching either the source address or destination address with an address of the match criteria of the rule; and
translating the matching address of the packet based on a NAT option address of the rule.

6. The method of claim 1, further comprising:
translating a network address of the packet based on the index into the service group and the rule,
wherein the rule comprises a NAT option including a NAT host group and the NAT service group.

7. The method of claim 1, further comprising:
translating a network address of the packet based on an index into a matching host group independently of the index into the matching service group,
wherein the rule comprises the matching host group and a NAT option including a NAT host group and the NAT service group.

8. The method of claim 1, further comprising configuring the rule via an operator interface.

9. A firewall comprising:
an ingress interface that receives a packet having a source address, destination address, source port, and destination port;
a rule storage comprising a plurality of active rules, at least one active rule including a matching criteria service group including a plurality of rows of source and destination port combinations and a NAT service group;
a matching engine configured to: compare the source port and destination port to the plurality of rows of source and destination port combinations, find a matching row, and determine an index of the matching row;
a translation engine configured to translate the source and destination ports of the packet to source and destination ports indicated by the NAT service group based on the index of the matching row; and
an egress interface configured to transmit the packet to the destination address.

10. The firewall of claim 9, further comprising an operator interface configured to allow an operator to configure the active rules.

11. The firewall of claim 9, wherein the index into the service group is a row of the service group.

12. The firewall of claim 11, wherein the index into the service group further includes an offset into a range of ports within the row.

13. The firewall of claim 9, wherein the translation engine is further configured to:
translate a network address of the packet based on the index into the service group and the at least one active rule, wherein the at least one active rule comprises a NAT option including a NAT host group and the NAT service group.

13. The firewall of claim 9, wherein the translation engine is further configured to:
translate a network address of the packet based on an index into a matching host group independently of the index into the matching service group, wherein the active rule comprises the matching host group and a NAT option including a NAT host group and the NAT service group.

14. A non-transitory machine readable storage medium encoded with instructions executable by a processor of a firewall, the non-transitory machine readable storage medium comprising:
instructions for receiving a packet having a source address, destination address, source port, and destination port;
instructions for comparing the packet to match criteria of a rule, wherein the match criteria includes at least one service group having a plurality of port combinations;
instructions for matching both the source port and destination port with one of the plurality of port combinations;
instructions for determining an index into the service group of the matching port combination; and
instructions for translating a port of the packet based on the index into the service group and a NAT service group defined for the rule.

15. The non-transitory machine readable storage medium of claim 14, wherein the index into the service group is a row of the service group.

16. The non-transitory machine readable storage medium of claim 15, wherein the index into the service group further includes an offset into a range of ports within the row.

17. The non-transitory machine readable storage medium of claim 16, wherein the instructions for translating the port of the packet comprise instructions for adding the offset to the first port number in a range of port numbers in a row of the NAT service group.

18. The non-transitory machine readable storage medium of claim 14, further comprising:
instructions for matching either the source address or destination address with an address of the match criteria of the rule; and
instructions for translating the matching address of the packet based on a NAT option address of the rule.

19. The non-transitory machine readable storage medium of claim 14, further comprising:
instructions for translating a network address of the packet based on the index into the service group and the rule, wherein the rule comprises a NAT option including a NAT host group and the NAT service group.

20. The non-transitory machine readable storage medium of claim 14, further comprising:
instructions for translating a network address of the packet based on an index into a matching host group independently of the index into the matching service group, wherein the rule comprises the matching host group and a NAT option including a NAT host group and the NAT service group.
